(19) United States
(12) Patent Application Publication
(10) Pub. No.: US 2010/0209012 A1
(43) Pub. Date: Aug. 19, 2010

(54) METHOD OF ENHANCEMENT OF MOVING STRUCTURE USING DOUBLE-WARPING

(75) Inventors: Raoul Florent, Ville Davray (FR); Nicolaas Hylke Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/679,329

(22) PCT Filed: Sep. 16, 2008
(86) PCT No.: PCT/IB08/53749

§ 371 Date: Mar. 22, 2010

(30) Foreign Application Priority Data
Sep. 21, 2007 (EP) 07116978.3

(51) Int. Cl. G06K 9/40

(52) U.S. Cl. 382/254

(57) ABSTRACT

A method for enhancing a moving structure of interest in a sequence of images is described, wherein images of the sequence are captured at different times and defined by a matrix of discrete pixels. The method comprises the steps of warping the data representative of pixels defining the images I(t) by using the data representative of the displacements V(t→to) to obtain data representative of pixels defining a second sequence of images A (t), applying an enhancement operation to images of the second sequence A (t) to obtain data representative of pixels defining a third sequence of images B(t), selecting data representative if pixels defining one image B(s) from the third sequence of images B(t), generating data representative of a reverse displacement V(to→O for pixels of the selected structure of interest between the image I(to) captured at reference time to and each image I(t) of the sequence of images captured at time t, and warping of the image B(s) using the data representative of the reverse displacement V(to→t) to obtain data representative of pixels defining a fourth sequence of images E(t).

### FIELD OF INVENTION

The present invention relates to imaging techniques for imaging moving structures of interest and, more particularly, to techniques for enhancement of discrete pixel images in an image sequence comprising a moving structure, such as those produced in medical imaging systems. Further, the invention may be used by an imaging system for Percutanerous Coronary Intervention (PCI) in catheter laboratories, to image cardiac stenosis, or during x-ray operation, e.g. angiography where potential stenosis may assessed.

### BACKGROUND OF THE INVENTION

In enhancing processes, images are registered with respect to a moving structure of interest as a as devices, e.g. stents biopsy needles, cardiac valves, catheter tips or leads, etc and then temporally integrated. This procedure can be extended to the boosting of anatomy parts, wherein e.g. a stenosis forms said structure of interest.

However, the visualisation requirements for moving structures as stenosis are much more constraining than for others, regarding to a clear view of the surrounding parts of said structure, the preservation of the natural structure deformation, and the selection of an optimally boosted image. A good visualization of such structures is mandatory because their grading, either visual or automatic, may directly impacts a treatment decision. The contrast of the stenosis is not always very high even after contrast-agent injection and the stenosis is submitted to large movements, both cardiac and respiratory. Of course, the actual grading of the stenosis is usually made on a static image, which may be selected. This suppresses the motion difficulty, but this also masks the dynamic local behaviour of the lesion which might influence diagnostic.

A device boosting technique, as presented in “Registration and Integration for Fluoroscopy Device Enhancement” James C. Ross, David Langan, RaviManjeshwar, John Kaufhold, Joseph Manak, and David Wilson. Miccai 2005, which is herewith incorporated by reference, can be used to improve a lesion visibility by temporally averaging the motion-compensated stenosis images. This drastically decreases the noise level, while homogenizing the contrast agent variations.

Applying the traditional device-boosting technique to (for instance) a stenosis is a priori valuable concerning noise reduction or contrast agent homogenizing, but may also creates several severe problems due to the fact that, when it comes to anatomy assessment, the visualisation requirements are much more constraining than for devices e.g. stents for the following reasons.

The stenosis is not isolated but part of a vessel tree, including many bifurcations and side-branches. It is important to keep a decent visualisation of those surrounding vessels because they may play a part in the pathology evaluation. The so-called device boosting technique has precisely the property of blurring the background while improving the visibility of the moving device. Applied to the stenosis, this may leads to a strong blurring of the surrounding vessels, which might constitute a very strong problem for the diagnostic integrity.

Likewise, the local deformation of the lesion is also to be taken into account when assessing a stenotic situation. Again, the traditional device-boosting technique leads to the freezing of that deformation, thus potentially impairing diagnostic.

Finally, because the contrast-agent appearance strongly varies during the acquisition, and because the stenosis registration process is bound to make some errors for some frames, it might be penalizing to rely on all the stenosis-boosting images, since that some images might be of lesser quality, including those built during poor contrast periods, or impacted by transitory registration errors.

According to the aforesaid problems and limitations, it might be an object of the present invention to solve at least partly some of the issues presented above.

### SUMMARY OF THE INVENTION

The present invention provides a technique for enhancing digital pixel images designed to respond to these needs.

An exemplary embodiment of the invention provides a method for enhancing a moving structure of interest in a sequence of images, wherein images of the sequence are captured at different times and defined by a matrix of discrete pixels. The method comprising the steps of generating data representative of pixels defining a first sequence of images, the sequence comprising a plurality of images I(t) each captured at a different time t with an image I(t₀) captured at reference time t₀, generating data representative of a displacement V(t→t₀) for pixels of the structure of interest between the images I(t) and the image I(t₀) of the first sequence of images, warping the data representative of pixels defining the images I(t) by using the data representative of the displacements V(t→t₀) to obtain data representative of pixels defining a second sequence of images A(t), applying an enhancement operation to images of the second sequence A(t) to obtain data representative of pixels defining a third sequence of images B(t), selecting data representative of pixels defining at least one image B(s) from the third sequence of images B(t), generating data representative of a reverse displacement V(t₀→t) for pixels of the selected structure of interest between the image I(t₀) captured at reference time t₀ and each image I(t) of the sequence of images captured at time t, and warping of the at least one image B(s) using the data representative of the reverse displacement V(t₀→t) to obtain data representative of pixels defining a fourth sequence of images E(t).

Moreover, an exemplary embodiment of the invention provides an imaging system for enhancing a moving structure of interest in a sequence of images, wherein images of the sequence are captured at different times and defined by a matrix of discrete pixels. The imaging system comprises a data acquisition unit configured to generate data representative of pixels defining a first sequence of images, the sequence comprising a plurality of images I(t) each captured at a different time t with an image I(t₀) captured at reference time t₀ and a signal processing circuit configured to execute the above mentioned steps.

Referring to the claims a method and system for enhancing of a moving target-object as a structure of interest, for instance a stenosis, is proposed that includes a boosting treatment in such way that the target-object is temporally boosted, wherein the surrounding visualisation, as side-branches in the case of the stenosis, or the local deformation of the target-object may kept intact (bending in the case of the stenosis).

In accordance with certain aspects of the method as claimed in claim 8, the global motion is compensated, thus offering stabilisation and zoom possibilities as claimed in claim 12.

Further, according to certain technical aspects of the claims at least one optimized boosted object view B(s) is selectable, manually or automatically, thus may excluding lesser quality images which otherwise may be present in a boosted sequence.

An essential feature of one exemplary consists in creating a result sequence R(t) in which at least one optimally boosted object image B(s) is first computed, and then inlayed in a non-boosted sequence I(t), wherein the natural motion of the object is kept intact, but with an optional global registration that compensates for the overall motion of the object, e.g. a stenosis.

The technique has been design for the optimal view of stenosis, but it can be extended to other moving anatomy parts or devices, in all the situations where temporal boosting may improves the visibility of the target-object, in particular in at least one image, while the requirement to keep both the deformation of the target-object as the structure of interest and the visibility of the surrounding is important. Thus, possible applications for the invention are biopsy needles, cardiac valves, catheter tips or leads.

In a further exemplary embodiment of the invention, the enhancement operation is selected from a group comprising an operation using temporal integration of at least two images of the second sequence of images A(t) and an operation using a spatial enhancement technique. Enhancement operations are disclosed e.g. in “Image Enhancement in Digital X-Ray Angiography, Eric Meijering, 2000, Ponsen & Looijen, Wageningen which is herewith integrated by reference.

In a further exemplary embodiment of the invention, the method further comprising the step of segmenting the structure of interest in every image of the first sequence of images to deriving data representative of a sequence of mask images F(t).

In yet another exemplary embodiment of the invention, the data representative of the displacement V(t→t₀) and/or the reverse displacement V(t₀→t) are generated using data representative of a sequence of mask images F(t).

In yet another exemplary embodiment of the invention, the data representative of the sequence of mask images F(t) comprising pixel values that are representative for the probability for pixels of said pixel values to belong to the structure of interest.

In yet another exemplary embodiment of the invention, the method further comprising the step of combining of data representative of the first sequence of images and of data representative of the fourth sequence of images E(t) to obtain data representative of pixels defining a fifth sequence of images M(t).

In yet another exemplary embodiment of the invention, the merging is performed by using the data representative of the sequence of mask images F(t).

In yet another exemplary embodiment of the invention, the method further comprising the step of applying a geometrical transformation, precisely, a global geometrical transformation, to data representative of pixels defining the structure of interest in images of one of the sequences to obtain data G(t), wherein the geometrical transformation is applied in order to compensate a global motion of the structure of interest.

In yet another exemplary embodiment of the invention, the geometrical transformation is performed by using data representative of the sequence of mask images F(t).

In yet still another exemplary embodiment of the invention, a geometric barycentre of the structure of interest is generated from data representative of the sequence of mask images F(t). The said geometric barycentre is preferably used to define the global geometrical transformation G(t).

In yet another exemplary embodiment of the invention, the method further comprising the step of applying data G(t) to data representative of pixels defining the fifth sequence of images M(t) in order to obtain data representative of a final sequence of images R(t).

In yet another exemplary embodiment of the invention, the method further comprising the step of applying a zoom function to data representative of a final sequence of images R(t).

In yet another exemplary embodiment of the invention, the method further comprising the step of displaying at least one sequence of images of a group comprising:

I(t), A(t), B(t), E(t), M(t) F(t) and R(t).

In yet another exemplary embodiment of the invention, the first sequence of images is acquired via a digital x-ray imaging system.

Aspects defined above and further aspects of the invention are apparent from the examples of embodiment to be described hereinafter and are explained with reference to the examples of embodiment.

The invention will be described in more detail hereinafter with reference to examples of embodiment but to which the invention is not limited.

### BRIEF DESCRIPTION OF THE DRAWINGS

FIG. 1 is a block diagram illustrating method steps for an exemplary method, an imaging system a computer readable medium or of a program element for enhancing a moving structure of interest in a sequence of images.

FIG. 2 is a schematically plan view of four exemplary discrete pixel images produced with a system of the imaging system of FIG. 1 and displayed with a display device.

### DETAILED DESCRIPTION

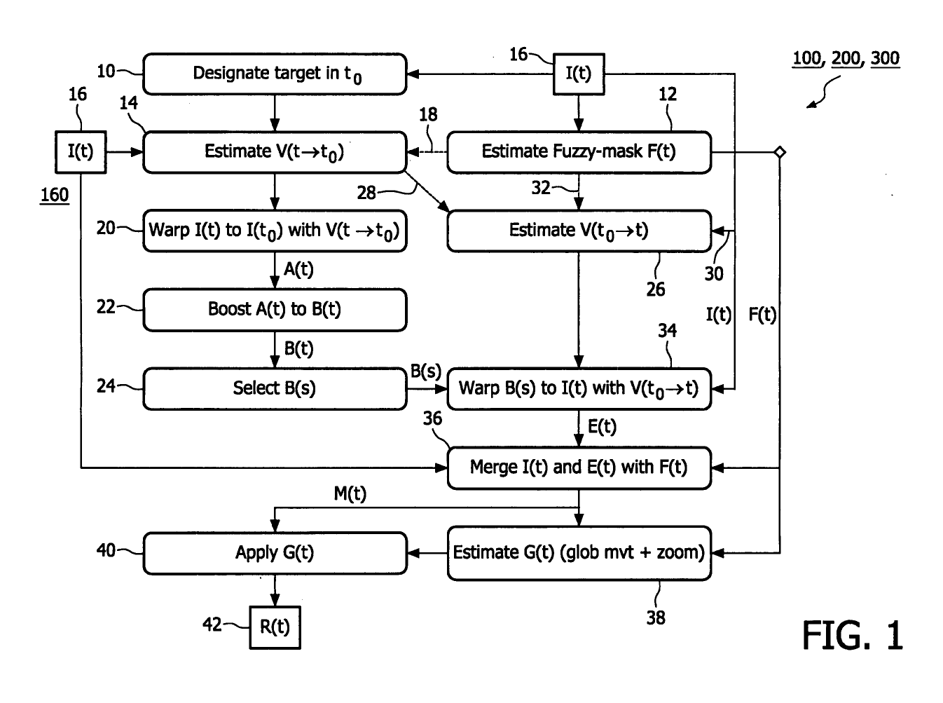

According to FIG. 1, a preferred method is described in the following:

The block diagram illustrates method steps for a method, executable by an imaging system 100, a computer readable medium 200, or of a program element 300 for enhancing a moving structure of interest in a sequence of images. The method comprises the steps of

### a) Target-Object Designation

First the target-object must be somehow designated in one image It₀ (at reference time t₀) (step 10). For any sequence S of images S(t) indexed by time t, it is defined that St refers to the image S(t). The said designation can be carried out through touch-screen pointing or via any other pointing devices, but it can also be automatic. For instance, in the case of the stenosis, automatic designation can be achieved through the detection of the contrast agent arrival at the location of a device, itself in the vicinity of the lesion.

### b) Fuzzy Object-Mask Computing

Thanks to the above designation, the segmentation (possibly fuzzy) of the target-object is computed. Any segmentation method is possible. This leads to the creation of a fuzzy mask 12 of the target-object, where each pixel value is representative of the probability of this pixel to belong to the target-object. In case of non-fuzzy segmentation, only the probability values 0 and 1 are possible. This step is applied to every image t, producing a fuzzy-mask Ft. Of course, tracking techniques can be involved to deduce Ft from the previous masks.

c) Target-Object Motion Estimation from t to t0

The motion field linking the target-object at time t to the same object at time t₀ is computed in step 14. Any motion estimation method can be used for that task. It can for instance rely on the computed fuzzy masks Ft and Ft₀, (12), (dashed arrow 18), but it can also directly be estimated form the images It (16) and It₀. This creates a vector field V(t→t₀).

d) Warping of It from V(t→t0)

Image It is warped (step 20) towards reference time t₀ thanks to the computed field V(t→t₀). This produces a series of image At. In case of complex motions, such as a bending stenosis, elastic warping is needed.

### e) Boosting

The images At are boosted (step 22) into a sequence Bt. This boosting operation usually involves temporal integration (using a plurality of images At such as At₁, At₂, At₃ for Bt₁ and At₂, At₃, At₄ for Bt₄ and so forth) but it might also depend on spatial enhancement techniques (e.g. high-frequency enhancement). In particular, combining temporal integration and edge enhancement is a good way to reach strong noise reduction without excessive contour blurring (due to imperfect registration prior temporal integration).

### f) Selection of at Least one Boosted Image

Not all the boosted frames in sequence Bt are necessarily of good quality. Some of them might be based on the integration of poorly contrasted images, others might be based on badly registered images (incorrect V(t→t₀)). This is why, in step 24, a selection of the best boosted images is achieved. This selection can be performed manually, but it can also rely on automatic measurements (contrast, registration confidence, etc). The selection result is the images Bs. At least one image Bs is selected.

### g) Inverse Motion Field Estimation V(t₀→t)

The inverse motion field linking the target-object at time t0 to time t is evaluated in step 26. This can be based on the simple inversion of the direct field V(t→t₀) (dashed arrow 28), or this can be achieved as in the case of the direct estimation procedure (relying on the images It (arrow 30), and/or on the fuzzy masks Ft (arrow 32).

h) Warping of Bs with V(t₀→t)

In step 34, the selected boosted image is warped back to the location of the target-object at time t thanks to vector field V(t₀→t). This creates the sequence Et whose gray-level content is only constituted from Bs values (however warped to match the moving target-object location at time t).

### i) Merging

The content of both It and Et are merged/combined thanks to the fuzzy mask Ft in step 36. Basically, where Ft indicates a high probability of presence of the target-object, image Et predominates in the merging, and in the opposite situation, It predominates. For every pixel site x, this can be achieved by:

Mt(x)=Ft(x)*Et(x)+(1−Ft(x))*It(x)

After merging, data of the computed sequence Mt contains both the optimal boosted view(s) of the target-object, together with the non-boosted background (keeping intact the bifurcations). In addition, the natural deformations of the target-object are also preserved.

### j) Global Geometrical Transform Estimation

In order to compensate for the target-object global motion (not its deformation), and in order to comply with a zooming operation, a global geometrical transform is estimated in step 38. For instance, the barycentre of Ft is computed and the translation that compensates the motion of this barycentre between t and t0 is incorporated to the geometrical transform, referred to as Gt.

### k) Global Geometrical Transform Application

Gt is applied to Mt in step 40 to produce the final result sequence Rt. In this sequence, a zoom is applied and the global motions of the target-object are compensated for. But Rt retains the natural motion of the target-object visualised in its optimal boosted version, and the background is preserved, including branching vessels.

Obviously for the skilled person, the final global registration and/or zooming are optional.

Additionally, instead of choosing only one optimal boosted view Bs, a sequence part Bj can be selected from Bt. In that case, an association procedure selecting for every image Bt its counterpart image Bj has to be defined (for instance based on the ECG, or on the respective motion content of Bt and Bj). This allows the inlaying of an optimally boosted sequence part in the final result Rt. In fact, the sequence Bj can range from a single image (for every j, j=constant=s) to the full sequence Bt (j=t).

The visualisation result (selected boosted interval warped back to the current frame, with background preservation, and optional global compensation and zoom) can be displayed by a display device, not shown here.

The shown method steps may aim to improve the visibility of stenosis and its grading. The method contributes to make the procedures quicker and safer.

The method described above can be extended to any moving anatomy parts or devices, in all the situations where temporal boosting improves the visibility of the target-object, in particular in at least one image, while the requirement to keep both the deformation of the target-object and the visibility of the surrounding is important. Possible applications: biopsy needles, cardiac valves, catheter tips or leads, etc.

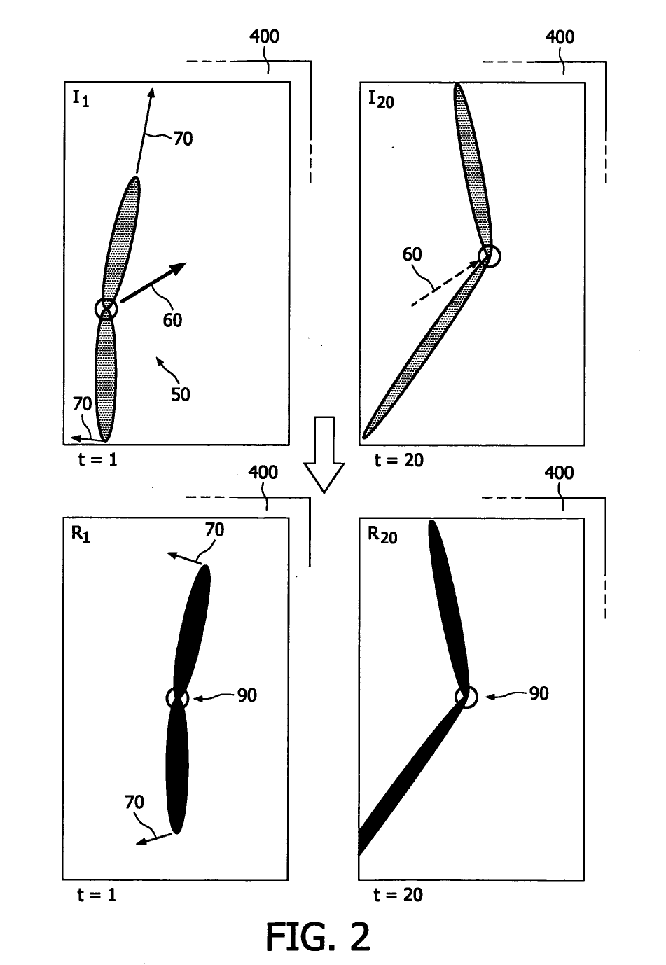

In a further embodiment shown in FIG. 2 a schematically plan view of four exemplary discrete pixel images of an internal anatomy of a patient produced with a system of the imaging system of FIG. 1 and displayed with a display device 400 is depicted. In the upper half of FIG. 2 two images I1 and I20 obtained from a first sequence of images I(t) are shown. The rest of the sequence I(t), images I2 to I19, is not shown. Image I1 is the first image of the sequence I(t), obtained via a digital x-ray imaging system 100 not shown here. Image I20 is the twentieth image of the sequence I(t). Each image shows two elliptic areas which should represent as a structure of interest 50 a vessel with a stenosis on their touch point (circle). The dashed and solid arrow 60 symbolizes a global motion direction of the vessel during the period of the sequence I(t), caused by respiration or moving of a patient and the like The arrows 70 show natural motion directions of the vessel during the period of the sequence, caused by cardiac contraction.

After the processing steps as claimed above, another final picture sequence R(t), represented by the two images R1 and R20 in the lower half of FIG. 2, is generated, wherein the global motion (arrow 60) of the structure of interest 50 is compensated compared to the first sequence of images I(t). Further, the natural deformation motion (arrow 70) of the structure of interest is remained compared to the first sequence I(t) of images. Additionally the structure of interest is enhanced in its gray scale values compared to the first sequence of images I(t). The circle at each touch point encircles a portion 90 of the structure of interest 50 remains at least largely fixed at the same region in each image of the sequence of images R(t). Preferably, a relevant part of the structure of interest 50, here the stenosis of the vessel is selected by an operator or automatically in an image of the first sequence and later orientated in the centre of the image sequence R(t).

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A method for enhancing a moving structure of interest in a sequence of images, wherein images of the sequence are captured at different times and defined by a matrix of discrete pixels, the method comprising the steps of:
a) generating data representative of pixels defining a first sequence of images, the sequence comprising a plurality of images I(t) each captured at a different time t with an image I(t₀) captured at reference time t₀;
b) generating data representative of a displacement V(t→t₀) for pixels of the structure of interest between the images I(t) and the image I(t₀) of the first sequence of images;
c) warping the data representative of pixels defining the images I(t) by using the data representative of the displacements V(t→t₀) to obtain data representative of pixels defining a second sequence of images A(t);
d) applying an enhancement operation to images of the second sequence A(t) to obtain data representative of pixels defining a third sequence of images B(t);
e) selecting data representative of pixels defining at least one image B(s) from the third sequence of images B(t);
f) generating data representative of a reverse displacement V(t₀→t) for pixels of the selected structure of interest between the image I(t₀) captured at reference time t₀ and each image I(t) of the sequence of images captured at time t;
g) warping of the at least one image B(s) using the data representative of the reverse displacement V(t₀→t) to obtain data representative of pixels defining a fourth sequence of images E(t).

2. The method of claim 1, wherein the enhancement operation is selected from a group comprising an operation using temporal integration of at least two images of the second sequence of images A(t) and an operation using a spatial enhancement technique.

3. The method according to claim 1, further comprising the step:
segmenting the structure of interest in every image of the first sequence of images to deriving data representative of a sequence of mask images F(t).

4. The method according to claim 3, wherein the data representative of the displacement V(t→t₀) and/or the reverse displacement V(t₀→t) are generated using data representative of a sequence of mask images F(t).

5. The method according to claim 3; wherein the data representative of the sequence of mask images F(t) comprising pixel values that are representative for the probability for pixels of said pixel values to belong to the structure of interest.

6. The method according to claim 1, further comprising the step:
combining of data representative of the first sequence of images and of data representative of the fourth sequence of images E(t) to obtain data representative of pixels defining a fifth sequence of images M(t).

7. The method according to claim 6; wherein the combining is performed by using the data representative of the sequence of mask images F(t).

8. The method according to claim 1, further comprising the step:
applying a geometrical transformation to data representative of pixels defining the structure of interest in images of one of the sequences to obtain data G(t), wherein the geometrical transformation is applied in order to compensate a global motion of the structure of interest.

9. The method according to claim 8; wherein the geometrical transformation is performed by using data representative of the sequence of mask images F(t).

10. The method according to claim 9, wherein a geometric barycentre of the structure is generated from data representative of the sequence of mask images F(t), wherein data of the geometric barycentre are used to define the geometrical transformation.

11. The method according to claim 8; further comprising the step:
applying data G(t) to data representative of pixels defining the fifth sequence of images M(t) in order to obtain data representative of a final sequence of images R(t).

12. The method according to claim 11; further comprising the step: applying a zoom function to data representative of a final sequence of images R(t).

13. The method according to claim 1; further comprising the step:
displaying at least one sequence of images of a group comprising:
I(t), A(t), B(t), E(t), M(t) F(t) and R(t).

14. The method according to claim 1; wherein the first sequence of images is acquired via a digital x-ray imaging system.

15. An imaging system (100) for enhancing a moving structure of interest in a sequence of images, wherein images of the sequence are captured at different times and defined by a matrix of discrete pixels, the imaging system comprising:
a data acquisition unit 116 configured to generate data representative of pixels defining a first sequence of images, the sequence comprising a plurality of
images I(t) (16) each captured at a different time t with an image I(t₀) captured at reference time t₀; and
a signal processing circuit configured to execute the following steps:
generating data representative of a displacement V(t→t₀) for pixels of the structure of interest between the images I(t) and the image I(t₀) of the first sequence of images;
warping the data representative of pixels defining the images I(t) by using the data representative of the displacements V(t→t₀);
generating data representative of pixels defining a second sequence of images A(t), to applying an enhancement operation to images of the second sequence A(t) to obtain data representative of pixels defining a third sequence of images B(t);
acquiring data representative of pixels defining one image B(s) from the third sequence of images B(t);
generating data representative of a reverse displacement V(t₀→t) for pixels of the selected structure of interest between the image I(t₀) captured at reference time t₀ and each image I(t) of the sequence of images captured at time t; and
warping of the image B(s) using the data representative of the reverse displacement V(t₀→t) to obtain data representative of pixels defining a fourth sequence of images E(t).

16. A computer readable medium 200 in which a program for enhancing a moving structure of interest in a sequence of images is stored, wherein images of the sequence are captured at different times and defined by a matrix of discrete pixels, which program, when executed by a processor, is adapted to control a method comprising the following steps:
a) generating data representative of pixels defining a first sequence of images, the sequence comprising a plurality of images I(t) each captured at a different time t with an image I(t₀) captured at reference time t₀;
b) generating data representative of a displacement V(t→t₀) for pixels of the structure of interest between the images I(t) and the image I(t₀) of the first sequence of images;
c) warping the data representative of pixels defining the images I(t) by using the data representative of the displacements V(t→t₀) to obtain data representative of pixels defining a second sequence of images A(t);
d) applying an enhancement operation to images of the second sequence A(t) to obtain data representative of pixels defining a third sequence of images B(t);
e) selecting data representative of pixels defining one image B(s) from the third sequence of images B(t);
f) generating data representative of a reverse displacement V(t₀→t) for pixels of the selected structure of interest between the image I(t₀) captured at reference time t₀ and each image I(t) of the sequence of images captured at time t;
g) warping of the image B(s) using the data representative of the reverse displacement V(t₀→t) to obtain data representative of pixels defining a fourth sequence of images E(t).

17. A program element (300) for enhancing a moving structure of interest in a sequence of images; wherein images of the sequence are captured at different times and defined by a matrix of discrete pixels, which program, when executed by a processor, is adapted to control a method comprising the following steps:
a) generating data representative of pixels defining a first sequence of images, the sequence comprising a plurality of images 1(t) each captured at a different time t with an image I(t₀) captured at reference time t₀;
b) generating data representative of a displacement V(t→t₀) for pixels of the structure of interest between the images I(t) and the image I(t₀) of the first sequence of images;
c) warping the data representative of pixels defining the images I(t) by using the data representative of the displacements V(t→t₀) to obtain data representative of pixels defining a second sequence of images A(t);
d) applying an enhancement operation to images of the second sequence A(t) to obtain data representative of pixels defining a third sequence of images B(t);
e) selecting data representative of pixels defining one image B(s) from the third sequence of images B(t);
f) generating data representative of a reverse displacement V(t₀→t) for pixels of the selected structure of interest between the image I(t₀) captured at reference time t₀ and each image I(t) of the sequence of images captured at time t;
g) warping of the image B(s) using the data representative of the reverse displacement V(t₀→t) to obtain data representative of pixels defining a fourth sequence of images E(t).

18. A method for displaying a sequence of images R(t); wherein data representing a first sequence of images I(t) are generated from an internal anatomy of a patient, wherein the internal anatomy of the patient comprises a moving structure of interest 50, the moving consisting of a global motion 60 and a natural deformation motion 70 of the structure of interest; the method comprising the following steps,
processing of data representing the first sequence of images such that the sequence of images R(t) is generated; wherein
the global motion 60 of the structure of interest 50 is at least mostly compensated compared to the first sequence of images I(t);
the natural deformation motion 70 of the structure of interest is at least mostly remained compared to the first sequence of images; and wherein
the structure of interest is enhanced compared to the first sequence of images.

19. The method of claim 18, wherein further a portion (90) of the structure of interest (50) remains at least largely fixed at the same region in each image of the sequence of images R(t).

20. The method of claim 18, wherein the processing uses the steps of the method for enhancing a moving structure of interest in a sequence of images, wherein images of the sequence are captured at different times and defined by a matrix of discrete pixels, the method comprising the steps of:
a) generating data representative of pixels defining a first sequence of images, the sequence comprising a plurality of images I(t) each captured at a different time t with an image I(t₀) captured at reference time t₀;
b) generating data representative of a displacement V(t→t₀) for pixels of the structure of interest between the images I(t) and the image I(t₀) of the first sequence of images;
c) warping the data representative of pixels defining the images I(t) by using the data representative of the displacements V(t→t₀) to obtain data representative of pixels defining a second sequence of images A(t);
d) applying an enhancement operation to images of the second sequence A(t) to obtain data representative of pixels defining a third sequence of images B(t);
e) selecting data representative of pixels defining at least one image B(s) from the third sequence of images B(t);
f) generating data representative of a reverse displacement V(t₀→t) for pixels of the selected structure of interest between the image I(t₀) captured at reference time t₀ and each image I(t) of the sequence of images captured at time t;
g) warping of the at least one image B(s) using the data representative of the reverse displacement V(t₀→t) to obtain data representative of pixels defining a fourth sequence of images E(t).

21. Display device 400, wherein the display device is adapted to display the sequence of images R(t) according to claim 18.

22. The sequence of images R(t) according to claim 18.
